(19) United States
(12) Patent Application Publication
(10) Pub. No.: US 2016/0217375 A1
(43) Pub. Date: Jul. 28, 2016

(54) METHOD AND SYSTEM FOR STENT RECOMMENDATION

(71) Applicant: Infinitt Healthcare Co., Ltd., Seoul (KR)

(72) Inventors: Tae Jun Choi, Seoul (KR); Han Young Kim, Seoul (KR); Dong Hoon Yu, Seoul (KR); Yu Hyeon Choi, Incheon (KR); Dae Gyu Min, Incheon (KR)

(73) Assignee: Infinitt Healthcare Co., Ltd.

(21) Appl. No.: 15/008,793

(22) Filed: Jan. 28, 2016

(30) Foreign Application Priority Data
Jan. 28, 2015 (KR) 10-2015-0013763

(51) Int. Cl. G06N 5/02; G06F 19/00

(52) U.S. Cl. CPC G06N 5/022; G06F 19/325

(57) ABSTRACT

A system and method for stent recommendation are disclosed herein. The stent recommendation system includes a processor and a database. The processor acquires an image of the body part of a subject where a stent is to be implanted, simulates a stent implantation target location for each of a plurality of types of stents based on the image, and computes a fitness score for each of the plurality of types of stents based on preset evaluation criteria. The processor displays at least one of the plurality of types of stents on a display screen as recommended stents based on the fitness score computed for each of the plurality of types of stents. The database stores the result data of the simulation performed for each of the plurality of types of stents.

### CROSS-REFERENCE TO RELATED APPLICATION

This application claims under 35 U.S.C. §119(a) the benefit of Korean Patent Application No. 10-2015-0013763 filed on Jan. 28, 2015, which is incorporated herein by reference.

### TECHNICAL FIELD

The present invention relates generally to a system and method for stent recommendation, and more particularly to a system and method that recommend an appropriate stent that is to be implanted in the body of a subject.

### BACKGROUND ART

Recently, due to reasons such as western dietary habits, the extension of the average life span, lack of exercise, etc., coronary artery diseases have rapidly increased. Coronary artery diseases occur because a coronary artery is narrowed or occluded due to stenosis and thus the metabolic demand of the heart muscle is not satisfied. A representative treatment method for coronary artery diseases is stent implantation, which is performed to mitigate stenosis by inserting a metallic mesh tube, i.e., a stent, into a lesion and then inflating it.

Stent implantation is a nonsurgical treatment method, and is advantageous in that physical, psychological and economic burdens from which a patient suffers are small because minimum incision, anesthesia and invasive manipulation are employed. However, stent implantation is disadvantageous in that it is difficult to ensure the accuracy of a medical procedure with a high level of difficulty because the medical procedure is dependent upon two-dimensional X-ray angiogram (2D XA) images and thus the understanding of a three-dimensional (3D) structure is dependent upon the intuition of a medical team and tactile feedback.

Furthermore, with the advancement of stents, stent implantation considerably reduces serious complications, such as the acute occlusion of a blood vessel, which may be caused by conventional coronary balloon angioplasty, to less than 1%, and enables coronary intervention to be applied to complicated lesions, such as a multi-vessel disease, an opening lesion, a bifurcation lesion, a left main artery lesion, etc. However, stent implantation still has the important problem of in-stent re-stenosis.

It is known that in-stent stenosis is related to extracellular matrix formation attributable to the rapid propagation of smooth muscle cells having moved from the media of a blood vessel, i.e., neointimal hyperplasia, platelet thrombus, or inflammatory reaction. It is reported that in-stent re-stenosis exhibited a disease rate ranging from about 15 to 20% for a simple lesion and a disease rate ranging from about 30 to 60% for a complicated lesion, such as a lesion of a diabetes patient, a bifurcation lesion, or the like.

As the number of stent implantation cases increases, the absolute frequency of in-stent re-stenosis also increases. Furthermore, the number of recurrences of re-stenosis after the percutaneous treatment of in-stent re-stenosis gradually increases. These problems have become new problems in the field of coronary intervention.

Conventionally, although many stent manufacture-related developments, such as a change in the structure of a stent and a change in the material of a stent, have been attempted in order to overcome the above problems, there may be a situation in which the life of a patient is threatened due to the misjudgment of a doctor because which of the numerous types of existing stents is most appropriate for the implantation target portion of the corresponding patient must be determined totally based on the knowledge and experience of the doctor. That is, the existing well-known technologies do not provide appropriate criteria or an appropriate method for the determination of which stent is most effective from a physiological or physical perspective.

Meanwhile, U.S. Patent Application No. 2013-0144573 entitled “Method and System for Patient-Specific Hemodynamic Assessment of Virtual Stent Implantation” discloses a method for assessment of virtual stent implantation in an aortic aneurysm, comprising: generating a patient-specific 4D anatomical model of the aorta from the 4D medical imaging data; adjusting a model representing mechanical properties of the aorta wall to reflect changes due to aneurysm growth at a plurality of time stages; generating a stable deformation configuration of the aorta for each of the plurality of time stages by performing fluid structure interaction (FSI) simulations using the patient-specific 4D anatomical model at each time stage based on the adjusted model representing the mechanical properties of the aorta wall at each time stage; performing virtual stent implantation for each stable deformation configuration of the aorta; and performing FSI simulations for each virtual stent implantation.

That is, this preceding technology is used to model the aorta of a specific patient using medical images and then assess virtual stent implantation based on the modeled aorta in a thermodynamic manner, and has the advantage of checking the effect of implantation by virtually simulating stent implantation before actual stent implantation. However, this preceding technology is disadvantageous in that a user cannot easily check the effect of simulation because there is provided a display structure in which a user cannot easily check the result values of the simulation at one time.

### SUMMARY OF THE DISCLOSURE

At least one embodiment of the present invention is intended to recommend an appropriate stent to be implanted in the body of a subject via virtual simulation.

At least one embodiment of the present invention is intended to provide criteria for the determination of which of the numerous conventional types of stents is most appropriate to the body portion of a subject where a stent is to be implanted.

At least one embodiment of the present invention is intended to provide information about the recommendation of a stent most appropriate to a subject in an intuitively understandable form.

At least one embodiment of the present invention is intended to display the results of the simulation of the implantation of stents, which is virtually performed, on a display screen in an easily viewable form.

According to an aspect of the present invention, there is provided a stent recommendation system, including a processor and a database. The processor includes an image acquisition unit, a computation unit, and a display control unit.

The image acquisition unit is configured to acquire an image of the body part of a subject where a stent is to be implanted; the computation unit is configured to simulate a stent implantation target location for each of a plurality of types of stents based on the image, and to compute a fitness score for each of the plurality of types of stents based on preset evaluation criteria; the display control unit is configured to display at least one of the plurality of types of stents on a display screen as at least one of recommended stent based on the fitness score computed for each of the plurality of types of stents; and the database is configured to store the result data of the simulation performed for each of the plurality of types of stents based on the image.

The stent recommendation system may further include a first interface control unit configured to provide a user input menu that enables a weight to be adjusted for each of the evaluation criteria; and the computation unit may be further configured to compute the fitness score based on a weight set for each of the evaluation criteria, and to adjust the weight for each of the evaluation criteria in response to the input of a user identified by the first interface control unit.

The computation unit may be further configured to compute the fitness score based on each of the evaluation criteria including at least one of fractional flow reserve (FFR), wall stress shear (WSS), velocity, and wall stress. The computation unit may be further configured to compute the fitness score based on a weight set for each of the evaluation criteria, and to adjust the weight based on at least one of personal information of the subject, diagnosis information and state information.

The display control unit may be further configured to display a recommended atmospheric pressure (ATM) value computed for each of the plurality of types of stents, together with the computed fitness score, on the display screen.

The display control unit may be further configured to display a recommended ATM value, computed based on at least one of personal information of the subject, diagnosis information and state information, and a stent symmetry index (SSI), on the display screen in connection with each of the plurality of types of stents.

The stent recommendation system may further include a second interface control unit configured to receive input regarding whether to display a value computed for each of the evaluation criteria for each of the plurality of types of stents from a user; and the display control unit may be further configured to display a recommended ATM value, computed for each of the plurality of types of stents, and the computed fitness score on the display screen, and to display the value, computed for each of the evaluation criteria, in connection with each of the plurality of types of stents in response to the input of the user.

The stent recommendation system may further include a third interface control unit configured to identify the input of a user corresponding to any one of the recommended stents displayed on the display screen; and the display control unit may be further configured to display a simulation image, corresponding to the recommended stent corresponding to the input of the user, on the display screen in response to the input of the user identified by the third interface control unit.

The stent recommendation system may further include a fourth interface control unit configured to identify the input of a user corresponding to any one of the recommended stents displayed on the display screen; the display control unit may be further configured to display an SSI graph, based on the ATM value of the recommended stent corresponding to the input of the user, on the display screen in response to the input of the user identified by the fourth interface control unit, to additionally display information, including the recommended ATM value of the recommended stent corresponding to the input of the user, on the graph, and to provide a user input menu for the recommended ATM value.

According to another aspect of the present invention, there is provided a stent recommendation method, including: acquiring an image of the body part of a subject where a stent is to be implanted; simulating a stent implantation target location for each of a plurality of types of stents based on the image, and computing a fitness score for each of the plurality of types of stents based on preset evaluation criteria; and displaying at least one of the plurality of types of stents on a display screen as at least one of recommended stent based on the fitness score computed for each of the plurality of types of stents.

The computing step may include computing the fitness score based on a weight set for each of the evaluation criteria, providing a user input menu that enables the weight to be adjusted for each of the evaluation criteria, and adjusting the weight for each of the evaluation criteria in response to the input of a user regarding the user input menu.

The computing step may include computing the fitness score based on each of the evaluation criteria including at least one of fractional flow reserve (FFR), wall stress shear (WSS), velocity, and wall stress.

The displaying may include displaying a recommended atmospheric pressure (ATM) value computed for each of the plurality of types of stents, together with the computed fitness score, on the display screen.

The displaying step may include displaying a recommended ATM value, computed based on at least one of personal information of the subject, diagnosis information and state information, and a stent symmetry index (SSI), on the display screen in connection with each of the plurality of types of stents.

The computing step may include computing the fitness score based on a weight set for each of the evaluation criteria, and adjusting the weight based on at least one of personal information of the subject, diagnosis information and state information.

The displaying step may include displaying a recommended ATM value, computed for each of the plurality of types of stents, and the computed fitness score on the display screen, receiving input regarding whether to display a value computed for each of the evaluation criteria for each of the plurality of types of stents from a user, and displaying the value, computed for each of the evaluation criteria, in connection with each of the plurality of types of stents in response to the input of the user.

The displaying step may include identifying the input of a user corresponding to any one of the recommended stents displayed on the display screen, and displaying a simulation image, corresponding to the recommended stent corresponding to the input of the user, on the display screen in response to the identified input of the user.

The displaying step may include identifying the input of a user corresponding to any one of the recommended stents displayed on the display screen, displaying an SSI graph, based on the ATM value of the recommended stent corresponding to the input of the user, on the display screen in response to the identified input of the user, additionally displaying information, including the recommended ATM value of the recommended stent corresponding to the input of the user, on the graph, and providing a user input menu for the recommended ATM value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the schematic configuration of a stent recommendation system according to an embodiment of the present invention;

FIG. 2 is a first block diagram of a stent recommendation system according to an embodiment of the present invention;

FIG. 3 is a second block diagram of a stent recommendation system according to an embodiment of the present invention;

FIG. 4 is a third block diagram of a stent recommendation system according to an embodiment of the present invention;

FIG. 5 is a fourth block diagram of a stent recommendation system according to an embodiment of the present invention;

FIG. 6 is a view showing a first embodiment in which recommended stents are displayed according to an embodiment of the present invention;

FIG. 7 is a view showing a second embodiment in which recommended stents are displayed according to an embodiment of the present invention;

FIG. 8 is a view showing an example in which a recommended ATM-related graph is displayed according to an embodiment of the present invention; and

FIG. 9 is an operation flowchart of a stent recommendation method according to an embodiment of the present invention.

### DETAILED DESCRIPTION OF THE DISCLOSURE

Embodiments of the present invention will be described in detail below with reference to the accompanying drawings. In the following description, detailed descriptions of related known elements or functions that may unnecessarily make the gist of the present invention obscure will be omitted.

Furthermore, in the following description of embodiments of the present invention, specific numerical values are merely examples.

The present invention relates to a stent recommendation system and method, and more particularly to a system and method for recommending an appropriate stent, to be implanted in the body of a subject, via virtual simulation.

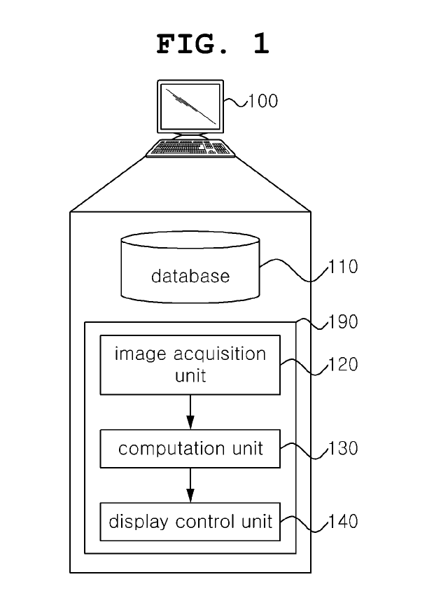

FIG. 1 is a diagram showing the schematic configuration of a stent recommendation system 100 according to an embodiment of the present invention.

Referring to FIG. 1, the stent recommendation system 100 of the present embodiment includes an image acquisition unit 120, a computation unit 130, a display control unit 140, and a database 110. The stent recommendation system 100 may include a processor 190, and the processor 190 may include the image acquisition unit 120, the computation unit 130, and the display control unit 140.

The image acquisition unit 120 acquires an image of the body part of the subject where a stent is to be implanted. In this case, the image acquired by the image acquisition unit 120 may be an image of the body part, before the implantation of the stent, which is acquired to virtually simulate the implantation of the stent before a doctor actually implants the stent in the body of the subject.

Furthermore, the image acquisition unit 120 may acquire a 3D anatomical model anatomical model generated to include the body part of the subject, particularly a 3D anatomical model including the structure of blood vessels.

In this case, the present invention may further include a modeling unit (not shown) configured to acquire the 3D anatomical model. The modeling unit may generate a 3D anatomical model, including the structure of blood vessels, based on the image acquired by the image acquisition unit 120.

The stent recommendation system and method according to the present invention perform simulation based on the generated 3D anatomical model, thereby recommending the most appropriate stent to the subject.

The computation unit 130 simulates a stent implantation target location regarding each of a plurality of types of stents based on the image (which particularly refers to a generated 3D anatomical model) acquired by the image acquisition unit 120, and computes a fitness score for each of the plurality of types of stents based on each of preset one or more evaluation criteria (fractional flow reserve (FFR), wall stress shear (WSS), velocity, wall stress, etc.).

That is, when the computation unit 130 receives a stent implantation target location from a user based on the acquired image, the computation unit 130 performs simulation regarding each of the plurality of types of stents for the received target location, and computes a fitness score for each of the stents. In this case, the plurality of types of stents may refer to stents that differ in size, shape, material, strength, flexibility, and/or an atmospheric condition when the stent is inflated.

Furthermore, the computation unit 130 computes a fitness scores for each of the stents based on each of the evaluation criteria including one or more of FFR, FFR, WSS, velocity, and wall stress. In this case, FFR refers to the ratio between the maximum blood flow rates of distal and proximal normal blood vessels in a coronary artery stenosis portion.

If angiostenosis occurs when the computation unit 130 computes a fitness score for each of the stents, the maximum values of FFR and wall stress increase, and the variances of WSS and velocity increase. In this case, the computation unit 130 may compute a fitness score based on a weight predetermined for each of the evaluation criteria (i.e., FFR, WSS, velocity, wall stress, etc.). Alternatively, the computation unit 130 may compute a fitness score based on a weight for each of the evaluation criteria, which is adjusted by a user (or a doctor).

Furthermore, the computation unit 130 may compute a recommended atmospheric pressure (ATM) value that enables damage to the wall of a blood vessel to be minimized when each of the plurality of types of stents is inflated. That is, the recommended ATM value is a value indicative of the extent to which each of the stents is inflated, and is used to recommend the most appropriate ATM when each of the stents is inflated.

In this case, the computation unit 130 computes a recommended ATM value while taking into account at least one of the personal information of a subject (for example, the age, gender, weight, height, etc. of a subject), diagnosis information (for example, information about whether a subject has a separate disease, the motive for the implantation of a stent, etc.) and state information (for example, the health state of the subject, information about the progression of the disease, etc.), and a stent symmetry index (SSI). The maximum value of the SSI value is increased because the pressure applied to the wall of a blood vessel is increased as a stent is inflated by applying higher atmospheric pressure. The system 100 of the present embodiment may provide a numerical value that can minimize damage to the wall of a blood vessel while inflating the stent most widely via the recommended ATM value computed as described above.

Furthermore, the computation unit 130 may compute a fitness score based on a weight set for each of the evaluation criteria, in which case the weight may be adjusted based on at least one of the personal information of a subject, diagnosis information, and state information.

As described above, the evaluation criteria may include FFR, WSS, velocity, wall stress, etc. Since the elasticity, restoring force and aging of a blood vessel may be influenced by the gender, age, etc. of a subject, the computation unit 130 may adjust the weight of each of the evaluation criteria by taking into account the characteristics of the blood vessel that are expected based on the personal information of the subject.

Furthermore, when a subject has a disease, such as hypertension, hypotension, diabetes, cardiac failure or the like, this disease may influence the characteristics of the blood vessel. Accordingly, the computation unit 130 may adjust the weight of each of the evaluation criteria by taking into account the extent of degradation of the characteristics of the blood vessel that is expected based on the diagnosis information of the subject.

Furthermore, the body fat ratio, body neural fat ratio, and body cholesterol ratio of the subject may be criteria for the health of the blood vessel of the subject. That is, the computation unit 130 may adjust the weight of each of the evaluation criteria by taking into account the characteristics of the blood vessel that is expected based on the state information of the subject.

Furthermore, the computation unit 130 may adjust the weight of each of the evaluation criteria by comparing the numerical value of each item of the evaluation criteria with a recommended reference numerical value. For example, since velocity in the blood vessel is to decrease after the implantation of the stent, the safety of blood flow within the blood vessel may be ensured only if the lowest velocity is ensured after the implantation of the stent. Accordingly, when the velocity of the stent before the implantation of the stent or after the implantation of the stent is not above a predetermined level, the computation unit 130 may preferentially ensure the lowest velocity by increasing the weight of the velocity of the evaluation criteria.

Alternatively, the computation unit 130 may increase the weights of the WSS and wall stress of the evaluation criteria by taking into account the shape, sinuosity, etc. of the blood vessel at a location in the blood vessel where the stent is to be implanted if there is strong possibility that items, such as WSS, wall stress, etc., exceed predetermined references.

The display control unit 140 displays at least some of the plurality of types of stents on a display screen as recommended stents based on fitness scores that are computed for the plurality of types of respective stents by the computation unit 130.

For example, the display control unit 140 may display stents having the five highest ones of the fitness scores, computed for the plurality of types of 12 stents, on the display screen as recommended stents.

The display control unit 140 may display a stent having the highest one of the computed fitness scores from the top, in which case stent types (for example, stent 1, stent 2, stent 3, etc.), together with respective computed fitness scores, may be displayed on the display screen.

Furthermore, the display control unit 140 may further provide an extended result menu, which enables the simulation result values of the respective stents to be viewed in detail, to the display screen. If a user clicks on the extended result menu displayed on the display screen, the system 100 may display the detailed information of the simulation numerical values for the respective stents in response to the click on the extended result menu input by the user.

Furthermore, the display control unit 140 may display the recommended ATM values, computed for the plurality of types of respective stents, together with the computed fitness scores, on the display screen.

That is, the display control unit 140 may first display stent types, stent fitness scores and recommended ATM values as simulation result values. Thereafter, when input regarding the extended result menu from a user is identified, the display control unit 140 may display evaluation criteria (FFR, WSS, velocity, wall stress, etc.) values for each of the stents in response to the input.

Furthermore, the display control unit 140 may provide recommended stent information to the display screen in the form of a table. The display control unit 140 additionally provides a scroll bar, thereby enabling the user to freely move the result values displayed on the screen by dragging them.

Furthermore, the display control unit 140 may display the recommended ATM values, computed based on at least one of the personal information of the subject, the diagnosis information and the state information, and the SSI, on the display screen in connection with the plurality of types of respective stents. In this case, an SSI graph based on the ATM values of the recommended stents may be displayed on the display screen in response to the input of the user.

The database 110 stores the result data of the simulation for each of the plurality of types of stents based on the image (which particularly refers to the generated 3D anatomical model) acquired by the image acquisition unit 120.

In the following description, additional components for the system 100 of the present invention are described with reference to the diagrams. In this case, the system 100 of the present invention further includes first to fourth interface control units, and the respective interface control units may refer to modules corresponding to given corresponding functions. Descriptions thereof will be given in detail below.

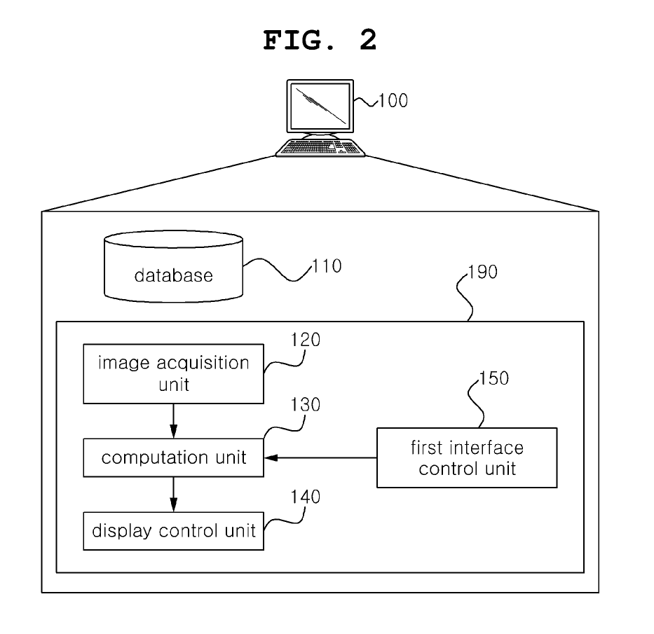

FIG. 2 is a first block diagram of a stent recommendation system according to an embodiment of the present invention.

Referring to FIG. 2, the system 100 of the present embodiment may further include a first interface control unit 150, in addition to the image acquisition unit 120, the computation unit 130 and the display control unit 140 present in the processor 190 of FIG. 1.

The first interface control unit 150 provides a user input menu that enables a weight to be adjusted for each of the evaluation criteria. The user may adjust a weight for each of the evaluation criteria for the plurality of types of stents via the user input menu provided by the first interface control unit 150.

Thereafter, the first interface control unit 150 identifies weight adjustment input information input by the user, and the computation unit 130 adjusts a weight for each of the evaluation criteria in response to the input of the user identified by the first interface control unit 150 and computes a fitness score by taking into account the adjusted weight for each of the evaluation criteria. The computed fitness score is displayed on the display screen by the display control unit 140.

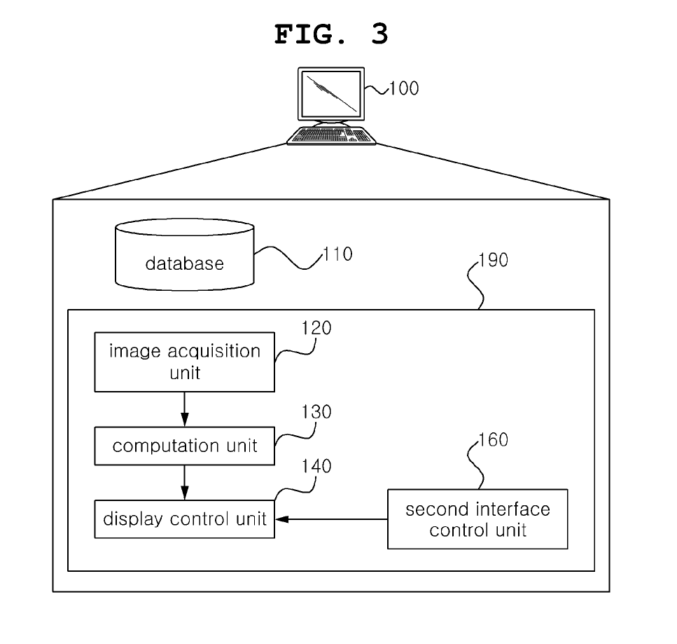

FIG. 3 is a second block diagram of a stent recommendation system according to an embodiment of the present invention.

Referring to FIG. 3, the system 100 of the present embodiment may further include a second interface control unit 160 in addition to the image acquisition unit 120, the computation unit 130 and the display control unit 140 present in the processor 190 of FIG. 1.

The second interface control unit 160 receives information about whether to display a computed value for each of the evaluation criteria (FFR, WSS, velocity, wall stress, etc.) for each of the plurality of types of stents from the input of the user, and identifies it. In this case, whether to display the computed value for each of the evaluation criteria via the second interface control unit 160 corresponds to whether to display the detailed information of a simulation result value via the above-described extended result menu in terms of meaning.

Furthermore, the display control unit 140 may display the computed recommended ATM value and the computed fitness score for each of the plurality of types of stents on the display screen, and may additionally display the computed value for each of the evaluation criteria in connection with each of the plurality of types of stents in response to the input of the user identified by the second interface control unit 160.

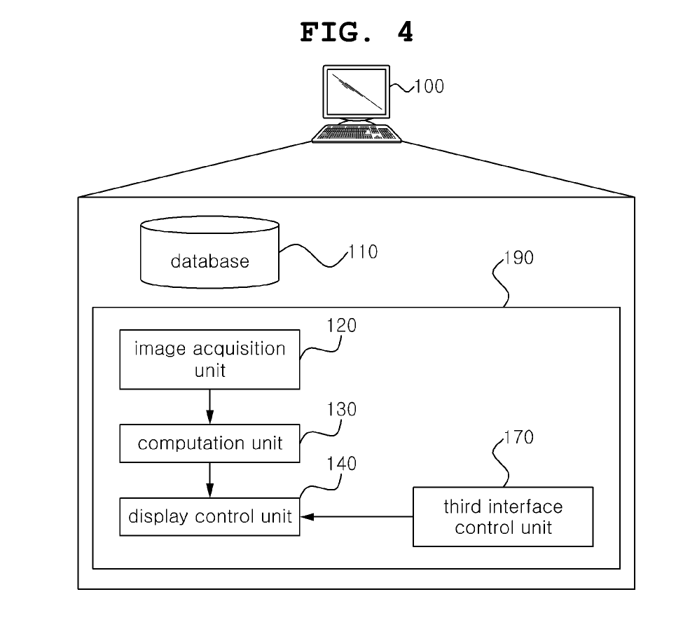

FIG. 4 is a third block diagram of a stent recommendation system according to an embodiment of the present invention.

Referring to FIG. 4, the system 100 of the present embodiment may further include a third interface control unit 170 in addition to the image acquisition unit 120, the computation unit 130 and the display control unit 140 present in the processor 190 of FIG. 1.

The third interface control unit 170 identifies the input of the user corresponding to any one of the recommended stents displayed on the display screen. In this case, the input of the user identified by the third interface control unit 170 may be input adapted to display a simulation image of the corresponding stent on the display screen.

The third interface control unit 170 identifies the input of the user (for example, a one click, a double click, a right mouse click, or the like) corresponding to any one of the stent types of the recommended stents, the stent fitness scores, recommended ATM values, and evaluation criteria values for the respective stents displayed on the display screen.

Furthermore, the display control unit 140 may display a simulation image corresponding to the recommended stent corresponding the input of the user on the display screen in response to the input of the user identified by the third interface control unit 170.

For example, when the user double-clicks on the recommended ATM value of stent 2 in information displayed on the display screen, the third interface control unit 170 identifies the double click as input adapted to provide a simulation image of stent 2, and the display control unit 140 displays a simulation image (for example, at least one of FFR, WSS, velocity and wall stress images for stent 2) corresponding to stent 2 on the display screen in response to the identified input of the user.

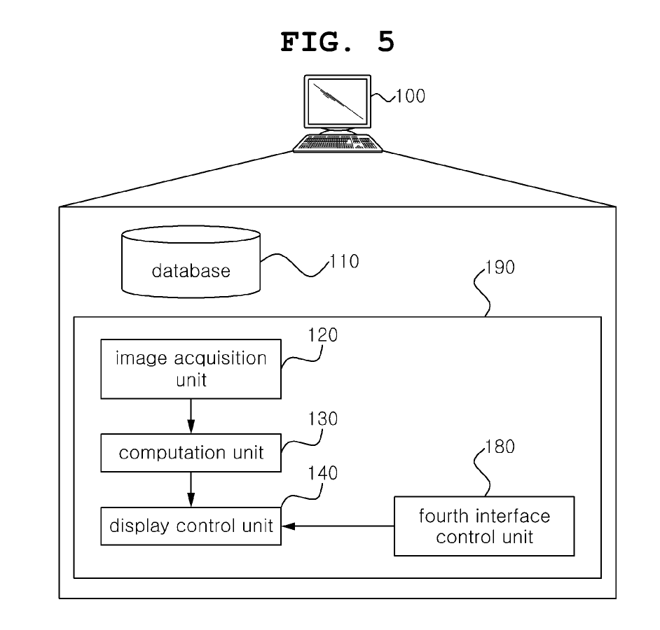

FIG. 5 is a fourth block diagram of a stent recommendation system according to an embodiment of the present invention.

Referring to FIG. 5, the system 100 of the present embodiment may further include a fourth interface control unit 180 in addition to the image acquisition unit 120, the computation unit 130, and the display control unit 140 present in the processor 190 of FIG. 1.

The fourth interface control unit 180 identifies the input of the user corresponding to any one of the recommended stents displayed on the display screen. In this case, the input of the user identified by the fourth interface control unit 180 may be input adapted to display a graph related to the recommended ATM of the corresponding stent on the display screen.

The display control unit 140 displays an SSI graph, based on the ATM value of the recommended stent corresponding to the input of the user, on the display screen in response to the input of the user identified by the fourth interface control unit 180.

In this case, the display control unit 140 may also display information, including the recommended ATM value of the recommended stent corresponding to the input of the user, on the displayed graph.

Furthermore, the display control unit 140 may provide a user input menu for the recommended ATM value. In this case, the user input menu for the recommended ATM value may refer to a menu that enables the user to check a stent ATM value, to manually modify the stent ATM value, or to request re-simulation.

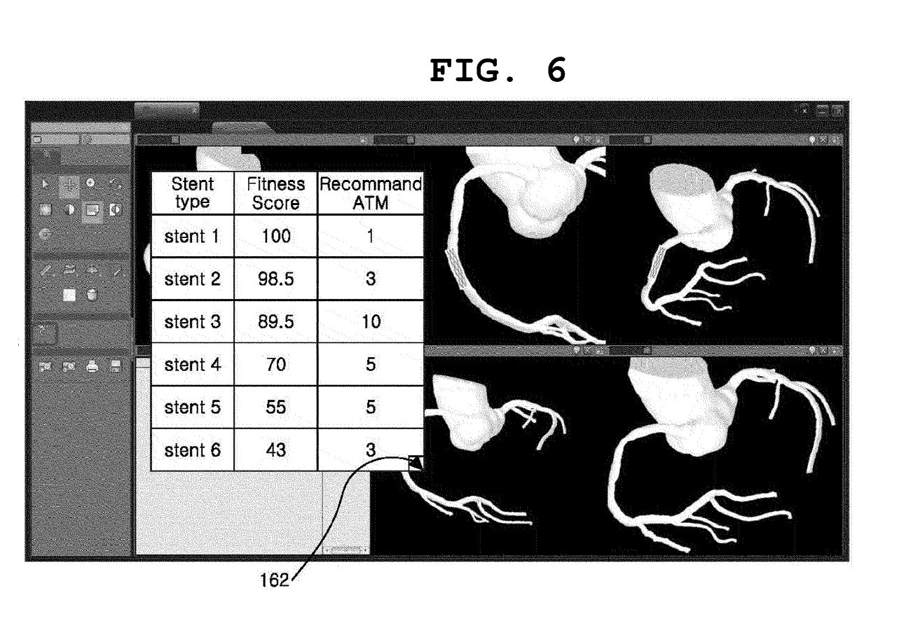

FIG. 6 is a view showing a first embodiment in which recommended stents are displayed according to an embodiment of the present invention.

Referring to FIG. 6, six stents (stents 1 to 6) may be displayed on the display screen of the present embodiment as recommended stents, and the six stents may be arranged and displayed in descending order of fitness scores. Furthermore, recommended ATM values may be displayed on the right side of the fitness scores.

In greater detail, stent 1 has a fitness score of 100 and has the highest fitness score of all the stents, and thus it is displayed on the first line of the table. Furthermore, the recommended ATM value of stent 1 is 1, which means that when stent 1 is inflated at 1 ATM during implantation, this is most suitable for the subject. Furthermore, stent 2 has a fitness score of 98.5 and exhibits the second highest fitness score below that of stent 1, and the recommended ATM value of stent 2 is 3.

Furthermore, in FIG. 6, the extended result menu 162 described above may be displayed at the right end of the table displayed on the display screen. The extended result menu 162 functions to provide the detailed information of a simulation result value (i.e., a computed value for each of the evaluation criteria including FFR, WSS, velocity, wall stress, etc.) for each of the stents.

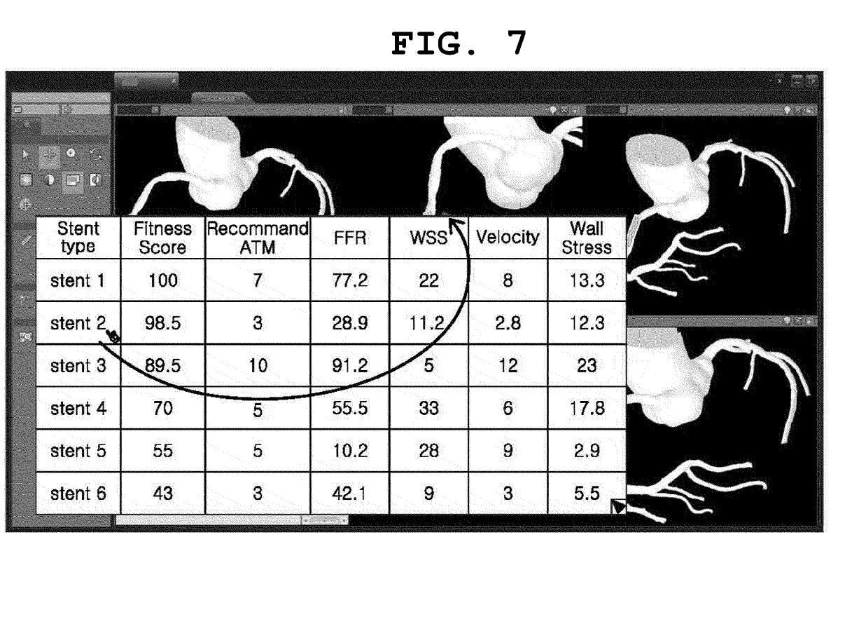

That is, when the user clicks on the extended result menu 162 in order to view the simulation result values in detail, the second interface control unit 160 of the present embodiment identifies the input of the user, and the display control unit 140 displays a computed value for each of the evaluation criteria for each of the stents in connection with each of the stents in response to the identified input of the user. The simulation screen thereof may be that shown in FIG. 7.

FIG. 7 is a view showing a second embodiment in which recommended stents are displayed according to an embodiment of the present invention.

Referring to FIG. 7, when a user clicks on an extended result menu, evaluation criteria (FFR, WSS, velocity, wall stress, etc.) values for each of the stents in addition to a stent type, a fitness score, and a recommended ATM value may be displayed on the display screen of the present embodiment. That is, when the extended result menu is clicked on, detailed numerical values for respective items are displayed, via which the user may compare a plurality of types of stents.

Furthermore, referring to FIG. 7, the third interface control unit 170 of the present embodiment may identify the input of the user (in this case, the input of the user is input adapted to display a simulation image of a corresponding stent on the display screen, and may be input, such as a one click or a double click on a related item) corresponding to any one of the recommended stent displayed on the display screen, and may display the simulation image of the corresponding stent on the display screen in response to the identified input of the user.

For example, when the user double-clicks on the stent type “stent 2” that ranks second in the information displayed on the display screen, at least one of FFR, WSS, velocity and wall stress images of stent 2 may be overlaid and displayed behind or in front of a table displayed on the display screen.

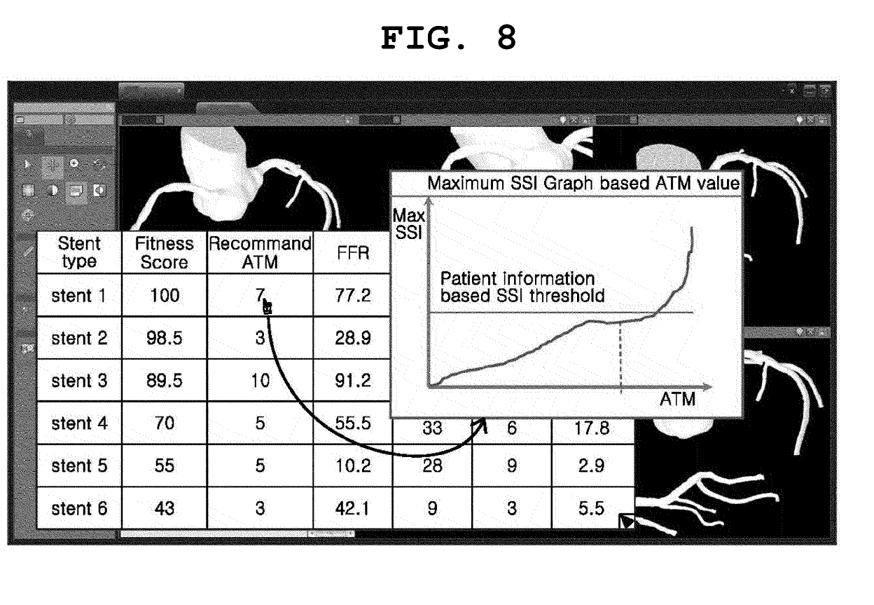

FIG. 8 is a view showing an example in which a recommended ATM-related graph is displayed according to an embodiment of the present invention.

Referring to FIG. 8, a recommended ATM-related graph for a corresponding stent may be displayed on a display screen in response to the input of the user identified by the fourth interface control unit 180 of the present embodiment.

For example, when a user double-clicks on 7, i.e., the recommended ATM value of stent 1, an SSI graph based on a recommended ATM value for stent 1 may be displayed on the display screen. In this case, the graph is representative of a recommended ATM value computed based on at least one of the personal information of a subject, diagnosis information and state information, and an SSI.

Furthermore, information including the recommended ATM value of the recommended stent corresponding to the input of the user may be displayed on the graph displayed on the display screen. Since the description thereof has been given in detail above, it is omitted.

Based on the detailed description given above, an operation flowchart of the present invention is described in brief.

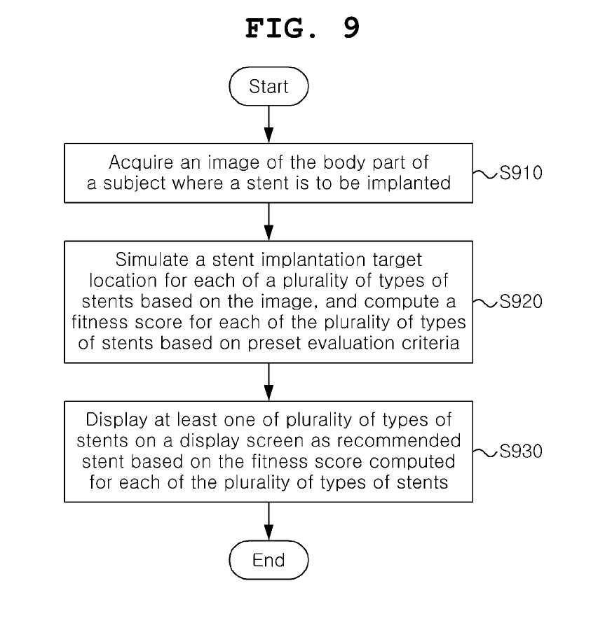

FIG. 9 is an operation flowchart of a stent recommendation method according to an embodiment of the present invention.

Referring to FIG. 9, first, the stent recommendation method according to the present embodiment includes step S910 of acquiring, by the image acquisition unit 120 of the stent recommendation system 100, an image of the body part of a subject where a stent is to be implanted.

In this case, the image acquired by the image acquisition unit 120 at step S910 may be an image of the body part, before the implantation of the stent, which is acquired to virtually simulate the implantation of the stent before a doctor actually implants the stent in the body of the subject. Furthermore, it may be possible to acquire a 3D anatomical model anatomical model generated to include the body part of the subject, particularly a 3D anatomical model including the structure of blood vessels.

The method according to the present embodiment may further include, after step S910, the step (not shown) of modeling the image, acquired by the image acquisition unit 120, into a 3D anatomical model in order to acquire the 3D anatomical model, via which the 3D anatomical model may be constructed based on the acquired image.

Thereafter, the computation unit 130 simulates a stent implantation target location regarding each of a plurality of types of stents based on the image (which particularly refers to a generated 3D anatomical model) acquired at step S910, and computes a fitness score for each of the plurality of types of stents based on preset evaluation criteria (FFR, WSS, velocity, wall stress, etc.), at step S920.

In this case, at step S920, the computation unit 130 may compute a fitness score based on a weight predetermined for each of the evaluation criteria (i.e., FFR, WSS, velocity, wall stress, etc.), or may compute a fitness score based on a weight for each of the evaluation criteria, which is adjusted by a user (or a doctor). In this case, a user input menu that enables a weight to be adjusted for each of the evaluation criteria may be provided by the first interface control unit 150.

Furthermore, the computation unit 130 may compute a recommended ATM (ATM) value that enables damage to the wall of a blood vessel to be minimized when each of the plurality of types of stents is inflated. Since a description thereof has been given in detail above, it is omitted.

Thereafter, at step S930, the display control unit 140 displays at least some of the plurality of types of stents on a display screen as recommended stents based on fitness scores that are computed for the plurality of types of respective stents at step S920.

In this case, at step S930, the display control unit 140 may display a stent having the highest one of the computed fitness scores from the top.

Furthermore, the display control unit 140 may first display stent types, stent fitness scores and recommended ATM values as simulation result values, and then may additionally display evaluation criteria (FFR, WSS, velocity, wall stress, etc.) values for each of the stents in response to the input of the user identified by the second interface control unit 160. Since a description thereof has been given in detail above, it is omitted.

Furthermore, at step 930, the display control unit 140 may display a simulation image of a corresponding stent corresponding to the input of the user on the display screen in response to the input of the user identified by the third interface control unit 170, and may display a graph, related to the recommended ATM of a corresponding stent corresponding to the input of the user, on the display screen in response to the input of the user identified by the fourth interface control unit 180. Since a description thereof has been given in detail above, it is omitted.

The stent recommendation method according to the embodiment of the present invention may be implemented in the form of program instructions that can be executed by a variety of computer means, and may be stored in a computer-readable storage medium. The computer-readable storage medium may include program instructions, a data file, and a data structure solely or in combination. The program instructions that are stored in the medium may be designed and constructed particularly for the present invention, or may be known and available to those skilled in the field of computer software. Examples of the computer-readable storage medium include magnetic media such as a hard disk, a floppy disk and a magnetic tape, optical media such as CD-ROM and a DVD, magneto-optical media such as a floptical disk, and hardware devices particularly configured to store and execute program instructions such as ROM, RAM, and flash memory. Examples of the program instructions include not only machine language code that is constructed by a compiler but also high-level language code that can be executed by a computer using an interpreter or the like. The above-described hardware components may be configured to act as one or more software modules that perform the operation of the present invention, and vice versa.

At least one embodiment of the present invention has the advantage of recommending an appropriate stent to be implanted in the body of a subject via virtual simulation.

At least one embodiment of the present invention has the advantage of providing criteria for the determination of which of the conventional numerous types of stents is most appropriate to the body portion of a subject where a stent is to be implanted.

At least one embodiment of the present invention has the advantage of providing information about the recommendation of a stent most appropriate to a subject in an intuitively understandable form.

At least one embodiment of the present invention has the advantage of displaying the results of the simulation of the implantation of stents, which is virtually performed, on a display screen in an easily viewable form.

At least one embodiment of the present invention has the advantage of simulating a stent implantation target location for each of a plurality of types of stents based on an image of the body part of a subject, and computing a fitness score for each of the plurality of types of stents based on preset evaluation criteria, thereby providing the most appropriate stent to the subject.

At least one embodiment of the present invention has the advantage of recommending a stent most efficient for a subject based on a weight for each of the evaluation criteria, which is adjustable by a user.

At least one embodiment of the present invention has the advantage of recommending a stent most efficient for a subject by taking into account at least one of the personal information of a subject, diagnosis information, and state information.

The present invention was derived from research conducted as a part of the Industrial Convergence Fundamental Technology Development Project sponsored by the Korean Ministry of Trade, Industry and Energy and the Korea Institute of Industrial Technology Evaluation and Planning [Project Management Number: 10044910; Project Name: Development of Integrated Software System for Supporting Diagnosis and Treatment of Cardiovascular Diseases based on 3D High-precision Simulation using Multiple Medical Images].

As described above, although the present invention has been described in conjunction with specific details, such as specific components and limited embodiments and drawings, these are provided merely to help the overall understanding of the present invention. The present invention is not limited to these embodiments, and various modifications and variations can be made based on the foregoing description by those having ordinary knowledge in the art to which the present invention pertains.

Therefore, the technical spirit of the present invention should not be defined based on only the described embodiments, and the following claims, all equivalents to the claims and equivalent modifications should be construed as falling within the scope of the spirit of the present invention.

What is claimed is:

1. A stent recommendation method, comprising:
acquiring, by a processor, an image of a body part of a subject where a stent is to be implanted;
simulating, by the processor, a stent implantation target location for each of a plurality of types of stents based on the image;
computing, by the processor, a fitness score for each of the plurality of types of stents based on preset evaluation criteria; and
displaying at least one of the plurality of types of stents on a display screen as at least one of recommended stent based on the fitness score computed for each of the plurality of types of stents.

2. The stent recommendation method of claim 1, wherein the computing comprises:
computing, by the processor, the fitness score based on a weight set for each of the evaluation criteria;
providing, by the processor, a user input menu that enables the weight to be adjusted for each of the evaluation criteria; and
adjusting, by the processor, the weight for each of the evaluation criteria in response to an input of a user via the user input menu.

3. The stent recommendation method of claim 1, wherein the computing comprises computing the fitness score based on each of the evaluation criteria including at least one of fractional flow reserve (FFR), wall stress shear (WSS), velocity, and wall stress.

4. The stent recommendation method of claim 1, wherein the displaying comprises displaying a recommended atmospheric pressure (ATM) value computed for each of the plurality of types of stents, together with the computed fitness score, on the display screen.

5. The stent recommendation method of claim 1, wherein the displaying comprises displaying a recommended ATM value, computed based on at least one of personal information of the subject, diagnosis information and state information, and a stent symmetry index (SSI), on the display screen in connection with each of the plurality of types of stents.

6. The stent recommendation method of claim 1, wherein the computing comprises:
computing, by the processor, the fitness score based on a weight set for each of the evaluation criteria; and
adjusting, by the processor, the weight based on at least one of personal information of the subject, diagnosis information and state information.

7. The stent recommendation method of claim 1, wherein the displaying comprises:
displaying, by the processor, a recommended ATM value, computed for each of the plurality of types of stents, and the computed fitness score on the display screen;
receiving, by the processor, input regarding whether to display a value computed for each of the evaluation criteria for each of the plurality of types of stents from a user; and
displaying the value, by the processor, computed for each of the evaluation criteria, in connection with each of the plurality of types of stents in response to the input of the user.

8. The stent recommendation method of claim 1, wherein the displaying comprises:
identifying, by the processor, an input of a user corresponding to any one of the recommended stent displayed on the display screen; and
displaying, by the processor, a simulation image, corresponding to the recommended stent corresponding to the input of the user, on the display screen in response to the identified input of the user.

9. The stent recommendation method of claim 1, wherein the displaying comprises:
identifying, by the processor, an input of a user corresponding to any one of the recommended stents displayed on the display screen;
displaying an SSI graph, by the processor, based on an ATM value of the recommended stent corresponding to the input of the user, on the display screen in response to the identified input of the user;
additionally displaying information, by the processor, including a recommended ATM value of the recommended stent corresponding to the input of the user, on the graph; and
providing, by the processor, a user input menu for the recommended ATM value.

10. A stent recommendation system, comprising:
a processor configured to:
acquire an image of a body part of a subject where a stent is to be implanted;
simulate a stent implantation target location for each of a plurality of types of stents based on the image; and
compute a fitness score for each of the plurality of types of stents based on preset evaluation criteria;
display at least one of the plurality of types of stents on a display screen as at least one of recommended stent based on the fitness score computed for each of the plurality of types of stents; and
a database configured to store result data of the simulation performed for each of the plurality of types of stents based on the image.

11. The stent recommendation system of claim 10, the processor is further configured to:
provide a user input menu that enables a weight to be adjusted for each of the evaluation criteria;
compute the fitness score based on a weight set for each of the evaluation criteria; and
adjust the weight for each of the evaluation criteria in response to an input of a user via the user input menu.

12. The stent recommendation system of claim 10, wherein the processor is further configured to compute the fitness score based on each of the evaluation criteria including at least one of fractional flow reserve (FFR), wall stress shear (WSS), velocity, and wall stress.

13. The stent recommendation system of claim 10, wherein the processor is further configured to display a recommended atmospheric pressure (ATM) value computed for each of the plurality of types of stents, together with the computed fitness score, on the display screen.

14. The stent recommendation system of claim 10, wherein the processor is further configured to display a recommended ATM value, computed based on at least one of personal information of the subject, diagnosis information and state information, and a stent symmetry index (SSI), on the display screen in connection with each of the plurality of types of stents.

15. The stent recommendation system of claim 10, wherein the processor is further configured to:
compute the fitness score based on a weight set for each of the evaluation criteria; and
adjust the weight based on at least one of personal information of the subject, diagnosis information and state information.

16. The stent recommendation system of claim 10, the processor is further configured to:
receive input regarding whether to display a value computed for each of the evaluation criteria for each of the plurality of types of stents from a user;
display a recommended ATM value, computed for each of the plurality of types of stents, and the computed fitness score on the display screen; and
display the value, computed for each of the evaluation criteria, in connection with each of the plurality of types of stents in response to the input of the user.

17. The stent recommendation system of claim 10, the processor is further configured to:
identify an input of a user corresponding to any one of the recommended stents displayed on the display screen; and
display a simulation image, corresponding to the recommended stent corresponding to the input of the user, on the display screen in response to the input of the user identified by the processor.

18. The stent recommendation system of claim 10, the processor is further configured to:
identify an input of a user corresponding to any one of the recommended stents displayed on the display screen;
wherein the processor is further configured to display an SSI graph, based on an ATM value of the recommended stent corresponding to the input of the user, on the display screen in response to the input of the user identified by the processor, to additionally display information, including a recommended ATM value of the recommended stent corresponding to the input of the user, on the graph, and to provide a user input menu for the recommended ATM value.
